(19) United States
(12) Patent Application Publication
(10) Pub. No.: US 2002/0172001 A1
(43) Pub. Date: Nov. 21, 2002

(54) Modular input device system for a portable computing device

(76) Inventors: Steven S. Homer, Tomball, TX (US); Lee W. Atkinson, Houston, TX (US); Charles A. Sellers, Houston, TX (US); Michele B. Bovio, Houston, TX (US)

Correspondence Address: Robert A. Van Someren, Fietcher, Yoder & Van Someren, P.O. Box 692289, Houston, TX, 77269-2289, US

(21) Appl. No.: 09/860,128

(22) Filed: May 17, 2001

(51) Int. Cl. G06F 1/16

(52) U.S. Cl. 361/683; 361/680

(57) ABSTRACT

The present technique is associated with modular input devices for a computing device, such as a computer system. The technique allows a user to swap input devices according to the needs of the user, thereby adding functionality without increasing the size, space, or computing requirements of the computing device. In one aspect, the technique provides a biometric analysis device configured to identify the user for access to the computing device.

### FIELD OF THE INVENTION

The present technique relates generally to the field of computer systems, and more specifically, to modular input devices for personal computer systems. The present technique is a system and method for interchangeably integrating a user identification device with a computer system via an externally accessible receptacle.

### BACKGROUND OF THE INVENTION

A computer system generally comprises a variety of electronic components for processing data and a plurality of input and output devices for communicating data between the computer system and a user or an external device. For example, the computer system may comprise a processor, a plurality of integrated circuits (e.g., a motherboard), a plurality of memory devices (e.g., a hard-drive, a CD-ROM drive, a DVD-ROM drive, a floppy disk drive, and RAM), and a variety of software (e.g., an operating system and specific applications). The computer system also may include various input/output devices, such as a monitor, a printer, a keyboard, a pointing device (e.g., a mouse or a joystick), an audio device (e.g., a speaker or a microphone), a video device (e.g., a video camera), and a variety of other devices for communicating information.

In a desktop computer system, many of the input/output devices are stand-alone devices (e.g., a mouse, a keyboard, or other pointing device). Space, size, and efficiency is generally not a critical factor. However, in portable computer systems (e.g., a laptop or palm top computer), where space, size and efficiency is a critical factor, many of the input/output devices are fixed or integrated into the portable computer system. For example, laptop computers generally have a keyboard and a pointing device (e.g., similar to functions of a mouse) integrated into the unit. Laptop computers employ a variety of pointing devices, such as point-sticks, touch pads, and roller balls. In conjunction with these pointing devices, one to three buttons are generally included for making selections and for other functions. However, these input/output devices are generally fixed into the portable computer system such that the devices cannot be exchanged with other input/output devices. To add an input/output device, an external input/output device is generally coupled to the portable computer system at an appropriate port (e.g., a serial or parallel port). For example, an external keyboard or mouse can be plugged into a port on a rear panel of the portable computer system.

Moreover, security concerns are continually growing with respect to computer systems, networks and the Internet. As computer systems become more portable and more connected (e.g., networks), the need for user authorization systems and integrated security systems becomes increasingly important. Portable computers, such as laptops and palmtops, are subject to an even greater security risk during mobile use. Although software security systems are available, such security measures may be inadequate or undesirable for certain applications. Moreover, portable computers have limited space for input devices and limited memory for software applications.

Accordingly, there is a need for a technique for exchanging input/output devices in a computer system, particularly in a portable computer system, to provide flexible functionality while maintaining a relatively small and integrated package. Furthermore, there is a need for a technique that would provide for an integrated user identification device for user authentication and security.

### SUMMARY OF THE INVENTION

The present technique is associated with modular input devices for a computing device, such as a portable computer (e.g., a laptop or a palmtop). The technique allows a user to swap input devices according to the needs of the user, thereby adding functionality without increasing the size, space, or computing requirements of the computing device. In one aspect, the technique provides a modular structure configured to allow the user to integrally insert (and remove and/or swap) one of a plurality input devices into the computing device, including a biometric identification device (e.g., a fingerprint reader device). In another aspect, the technique allows the user to swap the input devices during operation of the computing device. Accordingly, a variety of systems and methods may be employed within the scope of the present technique.

According to one aspect of the present technique, a system is provided for configuring a computer system. The system comprises a panel for the computer system and a receptacle disposed in the panel. The receptacle is configured to interchangeably accept one modular input device of a plurality of modular input devices configured for user identification.

According to another aspect of the present technique, a system is provided for user interaction with a computer system. The system comprises a modular input device configured for interchangeable integration into a receptacle of an external panel for the computer system, and configured for user authentication for access to the computer system.

Various other aspects of the present technique comprise methods provided for flexibly configuring and interacting with a computer system. Also, the present technique may comprise providing a unique portable computing device.

### BRIEF DESCRIPTION OF THE DRAWINGS

The invention will hereafter be described with reference to the accompanying drawings, wherein like reference numerals denote like elements, and:

FIG. 1 is a perspective view of a portable computer system illustrating an exemplary embodiment of the present technique;

FIG. 2 is a perspective view of the portable computer system having a modular input device exploded out from a receptacle in the portable computer system;

FIG. 3 is a top view of the portable computer system;

FIG. 4 is a perspective view of an exemplary embodiment of the modular input device; and

FIG. 5 is a perspective view of the portable computer system having a plurality of modular input devices exploded out from the receptacle, illustrating the interchangeability of the modular input devices.

### DETAILED DESCRIPTION OF SPECIFIC EMBODIMENTS

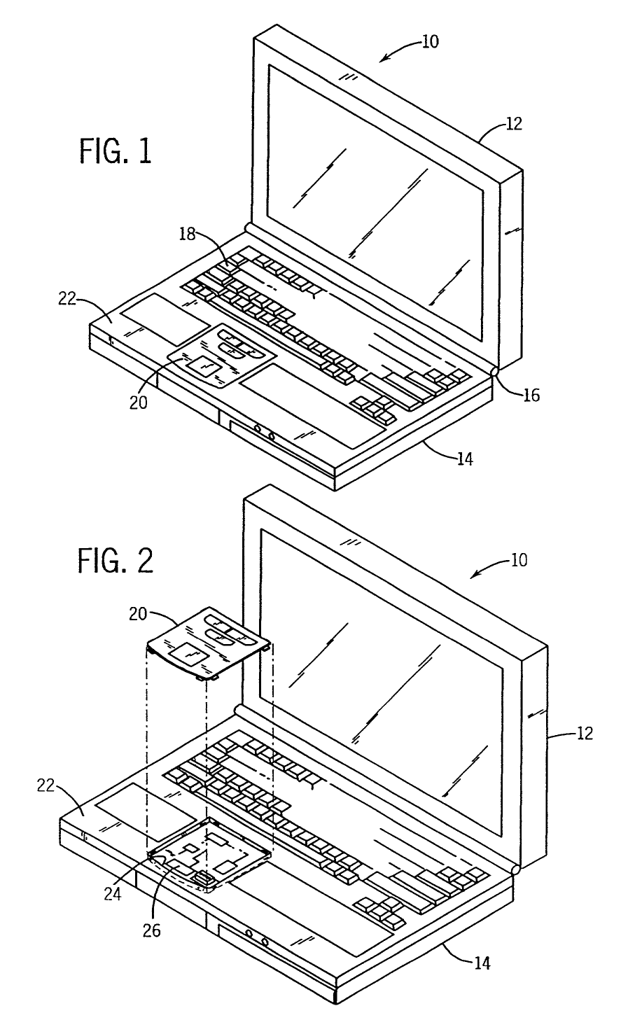

The present technique comprises a system and method for coupling, removing, and swapping modular input devices (e.g., pointing devices, keypads, user identification and authentication modules, etc.) configured for an electronic device such as a computer system. FIG. 1 is a perspective view of an exemplary embodiment of the present technique. As illustrated, the present technique comprises a computer system 10 having a display 12 coupled to an enclosure 14 at a hinge structure 16. Although the computer system 10 is illustrated as a portable computer system (e.g., a laptop computer), the computer system 10 may comprise a variety of portable, desktop, server, or other computer systems and/or electronic devices. As illustrated, the enclosure 14 has a keyboard 18 and a modular input device 20 disposed on a surface 22.

Referring now to FIG. 2, which is an exploded perspective view of the computer system 10, the modular input device 20 is illustrated as exploded out from a receptacle 24 in the surface 22 of the enclosure 14. As illustrated, internal components 26 of the computer system 10 are exposed in the receptacle 24. The internal components 26 may comprise a variety of electronic components, such as an integrated circuit, a processor, a hard drive, RAM memory, a battery, and various other electronic components for the computer system 10. The modular construction of the modular input device 20 allows relatively easy removal and insertion into the receptacle 24 of the enclosure 14. Accordingly, a variety of the modular input devices 20 (e.g., a pointstick, a rollerball, a touchpad, buttons, a fingerprint reader or a variety of other biometric identification devices, etc.) may be disposed in the receptacle 24.

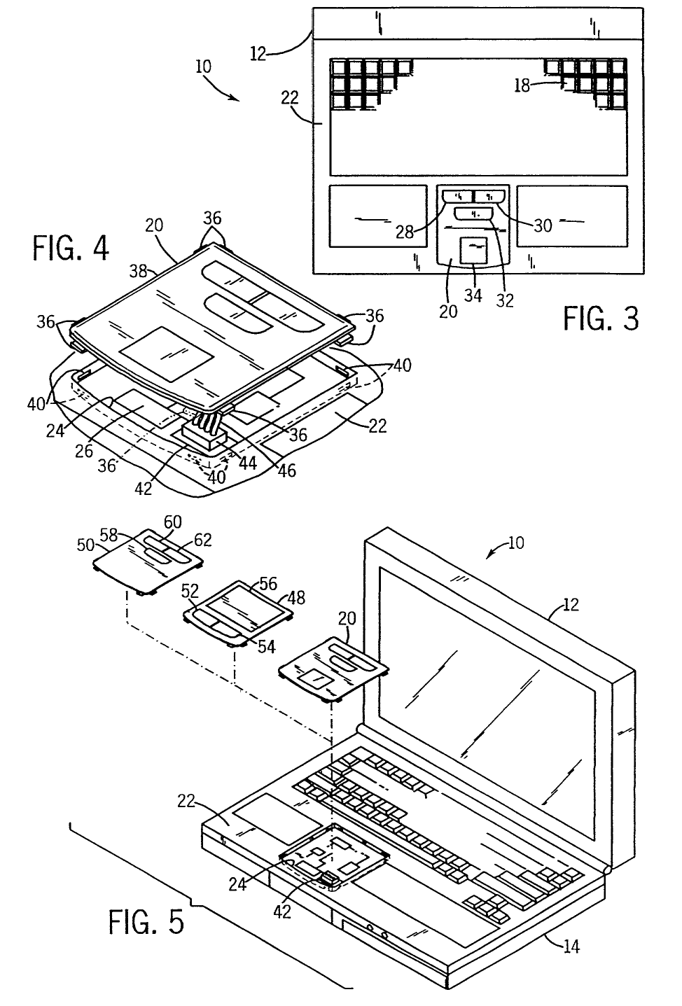

FIG. 3 is a top view of the computer system 10, illustrating exemplary elements of the modular input device 20. As illustrated, the modular input device 20 may have a plurality of buttons, such as buttons 28, 30, and 32, as well as a biometric identification device (e.g., fingerprint reader device 34). Although the present technique will be described with reference to the fingerprint reader device 34, a variety of other biometric identification devices may be utilized within the scope of the present technique. For example, various human biological traits may be identified or authenticated via the biometric identification device, such as eyes, fingerprints, hair, blood, face, palms, etc. The buttons 28, 30, and 32 may be used for a variety of functions, such as for selecting, for x-y movement, and for a variety of other standard and/or custom functions. The fingerprint reader device 34 allows user identification by scanning a fingerprint, such as by swiping the finger across the fingerprint reader device or by touching the fingerprint reader device to obtain a reading. For example, the fingerprint reader device may read ridges of the user's fingerprint to obtain a pattern for identifying the user. In this exemplary embodiment, the fingerprint reader device 34 may comprise a biometrics fingerprint reader device, such as those available from Identix Inc., Sunnyvale, Calif., USA. Furthermore, the fingerprint reader device 34 may comprise a device driver and other software. Moreover, the biometric identification device may embody a retinal scanner (i.e., to scan your eyes), or a scanner to identify a user according to other structural features such as facial features.

FIG. 4 is a perspective close-up view of the modular input device 20 and the receptacle 24 illustrating an exemplary structure for coupling the modular input device 20 to the receptacle 24. As illustrated, the modular input device 20 has a plurality of tabs 36 disposed around the perimeter of the modular input device 20 and recessed from a surface 38 of the modular input device 20. Within the receptacle 24, a plurality of slots 30 are disposed around the perimeter of the receptacle 24 for alignment and coupling with the plurality of tabs 36. The slots 40 are recessed from the surface 22 to allow the modular input device 20 to be coupled below the surface 22. Accordingly, the attachment structure of tabs 36 and slots 40 allows the modular input device 20 to be removably inserted into the receptacle 24, and easily removed from the receptacle 24 to swap it with another modular input device as desired by the user.

To provide electrical coupling between the modular input device 20 and the receptacle 24, an electrical receptacle 42 is provided in the receptacle 24 for removably accepting an electrical plug 44 extending from and coupled to the modular input device 20. As illustrated, the modular input device 20 comprises a plurality of conductors 46 extending from the modular input device 20 to the electrical plug 44. For example, the plurality of conductors 46 may comprise a set of four conductors configured for a USB connection between the modular input device 20 and the computer system 10.

Accordingly, the present technique may be configured for an architecture, such as a USB architecture, which allows hot-swapping or hot-plugging and removal of input/output devices. Thus, the user can easily remove the modular input device 20 from the receptacle 24, and may do so during operation of the computer system 10. Although the present technique is illustrated as having a plurality of tabs 36 and corresponding slots 30, a variety of other mechanical coupling structures may be used to couple the modular input device 20 to the receptacle 24 within the scope of the present technique. Similarly, a variety of other electrical connection assemblies may be used within the scope of the present technique.

FIG. 5 is a perspective view of the computer system 10 having a plurality of modular input devices exploded out from the receptacle 24. As discussed above, the structure of the modular input device 20 and the attachment structure for coupling the modular input device 20 to the receptacle 24 allows a user to remove the modular input device 20 and swap it out (e.g., hot-swap the devices) with another modular input device. As illustrated in FIG. 5, the present technique is illustrated as allowing the user to insert or swap one of a plurality of modular input devices (e.g., modular input devices 20, 48, and 50) into the receptacle 24. For example, the modular input device 48 may comprise buttons 52, 54, and a touch pad 56, and the modular input device 50 may comprise buttons 58, 60, and 62. The buttons 52 and 54 of the modular input device 48 may be used for selecting or other standard and/or custom functions for the computer system 10. The buttons 58, 60, and 62 of the modular input device 60 may be used for a variety of functions such for selecting, for x-y movement, or for a variety of other standard and/or custom functions for the computer system 10. Accordingly, the user may swap between one or more modular input devices in the receptacle 24 to allow the user to have the desired input/output functions at a particular time during the operation of the computer system 10. By utilizing a USB architecture, the present technique allows the plurality of modular input devices to be hot-swapped during operation of the computer system, thereby allowing maximum versatility for the computer system 10.

According to the embodiments illustrated in FIGS. 1-5, the present technique provides an exemplary method for flexibly configuring a computer system (e.g., portable, desktop, pda, etc.). The method comprises providing a structure having a panel accessible by a user for user interaction with the computer system. For example, the structure may be a laptop computer casing or a keyboard casing, and the panel may be the top surface adjacent to the keyboard. The method also comprises providing a receptacle in the panel to externally and interchangeably accept a desired device from a plurality of modular input devices (e.g., a fingerprint reader, a pointing device, a digital pad, an audio/video device, a keypad, etc.) which are configured for user interaction with the computer system.

Other aspects of the technique may comprise providing a coupling assembly (e.g., a snap-fit coupling assembly and/or an electrical coupling assembly) in the receptacle configured for removably accepting the desired device. The technique also may include configuring the computer system to allow insertion and removal of the desired device during operation of the computer system. For example, the computer system can be provided with a universal serial bus architecture and/or software adapted to allow insertion and removal of the desired device during operation of the computer system. The software also may be adapted to configure the computer system for the desired device.

Additionally, the technique may involve selecting the desired device, providing the desired device, inserting the desired device into the receptacle, and swapping the desired device with one of the plurality of modular input devices. Moreover, the act of swapping may comprise hot-swapping the desired device with one of the plurality of modular input devices during operation of the computer system. A plurality of the receptacles also may be provided to allow insertion of a plurality of the desired devices.

According to another aspect of the present technique, a method is provided for interacting with a computer system (e.g., portable, desktop, pda, etc.). The method comprises providing a modular structure for supporting an input device (e.g., a fingerprint reader, a pointing device, a digital pad, an audio/video device, a keypad, etc.). The modular structure is configured to allow insertion of the input device into a receptacle extending into a panel of the computer system, and the input device is configured for user interaction with the computer system.

The method also may include inserting, removing and/or swapping a desired device in the receptacle via the modular structure, wherein the desired device may be selected from a plurality of the input devices. Moreover, the method can include inserting one or more input devices into one or more of a plurality of the receptacles via the modular structure. For example, the modular structure may be inserted into the receptacle on a portable computing device (e.g., a laptop, pda/palmtop, etc.) and/or adjacent to a keyboard.

While the invention may be susceptible to various modifications and alternative forms, specific embodiments have been shown by way of example in the drawings and have been described in detail herein. However, it should be understood that the invention is not intended to be limited to the particular forms disclosed. For example, the present technique may be applied to a variety of computer systems, which would benefit from the ability to swap modular input devices such as a touch pad, a pointing device, a biometric analysis device, and other input devices. Moreover, the biometric analysis device can be adapted for analyzing a variety of human biological features, such as skin, blood, eyes, structural features of the face, hands, fingers (e.g., fingerprints), and other features. Accordingly, the invention is intended to cover all modifications, equivalents, and alternatives falling within the spirit and scope of the invention as defined by the following appended claims.

What is claimed is:

1. A system for configuring a computer system, comprising:
a panel for the computer system;
a receptacle disposed in the panel; and
a desired device interchangeably disposed in the receptacle, the desired device comprising a biometric identification module.

2. The system of claim 1, wherein the panel comprises a keyboard.

3. The system of claim 1, wherein the panel comprises a top-side of a portable computing device.

4. The system of claim 3, wherein the portable computing device comprises a laptop computer.

5. The system of claim 3, wherein the portable computing device comprises a palmtop computer.

6. The system of claim 1, wherein the receptacle comprises a modular structure configured to allow interchangeability among a plurality of modular input devices configured for user interaction with the computer system.

7. The system of claim 1, comprising an electrical architecture configured to allow insertion and removal of the desired device during operation of the computer system.

8. The system of claim 1, wherein the desired device comprises a plurality of buttons.

9. The system of claim 1, wherein the desired device comprises a pointing device.

10. The system of claim 1, wherein the biometric identification module comprises a fingerprint reader device.

11. A system for user interaction with a computer system, comprising a modular input device configured for interchangeable integration into a receptacle of an external panel for the computer system, wherein the modular input device comprises a user authentication device.

12. The system of claim 11, wherein the modular input device is configured to be disposed in a user input panel of a portable computing device.

13. The system of claim 11, wherein the modular input device is configured for external insertion into the receptacle.

14. The system of claim 11, wherein the modular input device comprises a pointing device.

15. The system of claim 11, wherein the modular input device comprises an electrical architecture configured to allow insertion and removal of the modular input device during operation of the computer system.

16. The system of claim 11, wherein the user authentication device comprises a fingerprint identification module.

17. A method for flexibly configuring a computer system, comprising:
providing a structure having a panel accessible by a user for user interaction with the computer system; and
providing a receptacle in the panel, wherein the receptacle is configured to externally and interchangeably accept a desired device from a plurality of modular input devices configured for user interaction with the computer system, the desired device comprising a biometric identification device.

18. The method of claim 17, wherein providing the receptacle comprises providing the receptacle adjacent to a keyboard.

19. The method of claim 17, wherein providing the receptacle comprises providing the receptacle on a portable computing device.

20. The method of claim 17, wherein providing the receptacle comprises providing the receptacle on a laptop computer.

21. The method of claim 17, wherein providing the receptacle comprises providing the receptacle on a palmtop computer.

22. The method of claim 17, comprising configuring the computer system to allow insertion and removal of the desired device during operation of the computer system.

23. The method of claim 22, wherein configuring the computer system comprises integrating an electrical architecture into the computer system to facilitate hot-swapping among the desired device and the plurality of modular input devices.

24. The method of claim 17, comprising inserting the desired device into the receptacle.

25. The method of claim 24, wherein inserting the desired device comprises inserting a fingerprint identification module into the receptacle.

26. The method of claim 17, comprising providing a plurality of the receptacles for a plurality of desired modular input devices, including the desired device.

27. The method of claim 17, comprising providing an option for selecting the desired device from the plurality of modular input devices, the plurality of modular input devices comprising a pointing device.

28. A method for interacting with a computer system, comprising
providing a modular structure for supporting an input device, wherein the modular structure is configured to allow insertion of the input device into a receptacle extending into a panel of the computer system, and the input device is configured for human biological analysis for user access to the computer system.

29. The method of claim 28, comprising providing for a selection of a desired device from a plurality of the input devices for insertion into the receptacle via the modular structure.

30. The method of claim 28, comprising configuring the modular structure to facilitate swapping of an installed device with a desired device from a plurality of user input devices during operation of the computer system.

31. The method of claim 28, comprising inserting the modular structure into the receptacle adjacent to a keyboard.

32. The method of claim 28, comprising adapting the modular structure for disposal into the receptacle on a user input panel of a portable computing device.

33. The method of claim 28, wherein the input device comprises a fingerprint reader module.

34. The method of claim 28, comprising hot-swapping the input device with one of a plurality of user input devices including a pointer device.

35. A portable computing device, comprising:
a display;
a user interaction panel;
a plurality of buttons disposed on the user interaction panel;
a receptacle extending into the user interaction panel; and
a modular input device interchangeably disposed in the receptacle, wherein the modular input device includes a human biological reader device.

36. The system of claim 35, wherein the user interaction panel comprises a keyboard.

37. The system of claim 35, wherein the receptacle is configured to allow swapping of the modular input device with one of a plurality of modular input devices.

38. The system of claim 35, comprising a plurality of the receptacles for a plurality of desired modular input devices.

39. The system of claim 35, wherein the portable computing device is configured to allow insertion and removal of the modular input device during operation of the portable computing device.

40. The system of claim 35, wherein the human biological reader device comprises a fingerprint reader module for identifying a user.

41. A portable computing device, comprising:
a user interaction panel;
a receptacle in the user interaction panel; and
a fingerprint reader module disposed in the receptacle, wherein the fingerprint reader module is configured for identifying a user for interaction with the portable computing device.

42. The system of claim 41, wherein the user interaction panel comprises a keyboard.

43. The system of claim 41, comprising a display.

44. The system of claim 41, wherein the receptacle is configured to allow swapping of the fingerprint reader module with a desired device from a plurality of modular input devices including the fingerprint reader module.

45. The system of claim 44, comprising an electrical architecture configured to allow insertion and removal of the desired device during operation of the portable computing device.
